(19) United States
(12) Patent Application Publication
(10) Pub. No.: US 2024/0429637 A1
(43) Pub. Date: Dec. 26, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Hideto NAKAMURA, Mie (JP); Tetsuya MIYAMURA, Mie (JP); Daisuke SAITO, Mie (JP)

(21) Appl. No.: 18/685,030

(22) PCT Filed: Aug. 19, 2022
(86) PCT No.: PCT/JP2022/031379

§ 371 Date: Feb. 20, 2024

(30) Foreign Application Priority Data
Aug. 27, 2021 (JP) 2021-138567

(51) Int. Cl. H01R 13/422

(52) U.S. Cl. CPC H01R 13/422

(57) ABSTRACT

It is aimed to provide a connector capable of improving the connection accuracy of a connection terminal and a mounting terminal by reducing stacking tolerances. A connector (10) is provided with a housing (11), a connection terminal (12) to be arranged inside the housing (11) and a mounting terminal (13) to be connected to the connection terminal (12). The mounting terminal (13) includes a flat plate-like guide portion (71). The housing (11) includes a slit (35) for positioning the guide portion (71).

### TECHNICAL FIELD

The present disclosure relates to a connector.

### BACKGROUND

Patent Document 1 discloses a housing for holding a busbar (hereinafter, referred to as a mounting terminal) and another connector for accommodating a plurality of connection terminals. The housing includes a connector fitting chamber. The mounting terminal includes branched terminal portions projecting into the connector fitting chamber. The other connector is fit into the connector fitting chamber of the housing. Each connection terminal is connected to the corresponding branched terminal portion.

### PRIOR ART DOCUMENT

### Patent Document

Patent Document 1: JP 2005-149934 A

### SUMMARY OF THE INVENTION

### Problems to be Solved

In the case of Patent Document 1, fitting tolerances between the other connector and the housing need to be also considered in addition to fitting tolerances between the connection terminals and the mounting terminal to maintain the connection accuracy of the connection terminals and the mounting terminal, which has tended to complicate a design.

Accordingly, the present disclosure aims to provide a connector capable of improving the connection accuracy of a connection terminal and a mounting terminal by reducing stacking tolerances.

### Means to Solve the Problem

The present disclosure is directed to a connector with a housing, a connection terminal to be arranged inside the housing and a mounting terminal to be connected to the connection terminal, the mounting terminal including a flat plate-like guide portion, and the housing including a slit for positioning the guide portion.

### Effect of the Invention

According to the present disclosure, it is possible to provide a connector capable of improving the connection accuracy of a connection terminal and a mounting terminal by reducing stacking tolerances.

### BRIEF DESCRIPTION OF THE DRAWINGS

FIG. 1 is an exploded perspective view of a connector of an embodiment.

FIG. 2 is a perspective view showing a state where a housing is fit to a mounting terminal.

FIG. 3 is a section showing the state where the housing is fit to the mounting terminal.

FIG. 4 is a back view of a first housing.

FIG. 5 is a front view of a second housing.

FIG. 6 is a front view of the mounting terminal.

FIG. 7 is a perspective view of the connection terminal when viewed from a bottom view direction.

FIG. 8 is a section showing a state where the first housing is held at a temporary locking position with respect to the second housing.

FIG. 9 is a section showing a state where the first housing is held at a complete locking position with respect to the second housing.

FIG. 10 is a side view showing the state where the first housing is held at the complete locking position with respect to the second housing.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing, a connection terminal to be arranged inside the housing and a mounting terminal to be connected to the connection terminal, the mounting terminal including a flat plate-like guide portion, and the housing including a slit for positioning the guide portion.

If the mounting terminal and the connection terminal are connected by mounting the mounting terminal into a receptacle and fitting the housing into the receptacle, the receptacle has to be considered for stacking tolerances and it becomes difficult to strictly maintain the connection accuracy of the mounting terminal and the connection terminal. In contrast, since the guide portion of the mounting terminal is directly positioned in the slit of the housing in the case of the above configuration, the receptacle needs not be considered for tolerances and, accordingly, accuracy can be improved. Further, the connector can be miniaturized by omitting the receptacle.

(2) Preferably, the connection terminal includes a contact point portion exposed on an outer surface, and the guide portion contacts and is connected to the contact point portion.

According to this configuration, since the mounting terminal needs not be provided with a dedicated connecting part to the connection terminal, e.g. a tab such as a branched terminal portion, the configuration can be simplified and the stacking tolerances can be further reduced.

(3) The guide portion may have a slide-contact surface between a connecting part to be connected to the contact point portion and a tip in an insertion direction into the slit, the contact point portion being slidable in contact with the slide-contact surface, and the guide portion may have an inclined surface receding to the connecting part side toward the slide-contact surface on the tip.

According to this configuration, the contact point portion of the connection terminal can wipe and remove an oxide film formed on the surface of the contact point portion by sliding in contact with the slide-contact surface of the guide portion in an assembly process. Further, the contact point portion can be guided by the inclined surface of the guide portion and smoothly reach the slide-contact surface.

(4) The housing may include a resiliently deformable lock portion, and the guide portion may include a lock receiving portion to be locked by the lock portion.

According to this configuration, since the guide portion has a locking function in addition to a guiding function and a dedicated locking function for the lock portion needs not be provided on the mounting terminal side, the configuration of the mounting terminal side can be simplified.

(5) The housing may be configured to be divisible into a first housing and a second housing, the first housing may include a resiliently deformable locking lance for locking the connection terminal, and the second housing may include the slit and a retainer portion for restricting resilient deformation of the locking lance and be higher in rigidity than the first housing.

According to this configuration, the second housing can be rigid enough to position and hold the guide portion. Further, the first housing can be flexible to enable the deflection of the locking lance.

(6) The second housing may include a resiliently deformable lock portion for locking the guide portion.

Since the second housing is higher in rigidity than the first housing, the second housing can easily ensure rigidity enough to lock the guide portion and the lock portion can be satisfactorily provided.

### Details of Embodiment of Present Disclosure

A specific example of an embodiment of the present disclosure is described below with reference to the drawings. Note that the present invention is not limited to this illustration, but is represented by claims and intended to include all changes in the scope of claims and in the meaning and scope of equivalents.

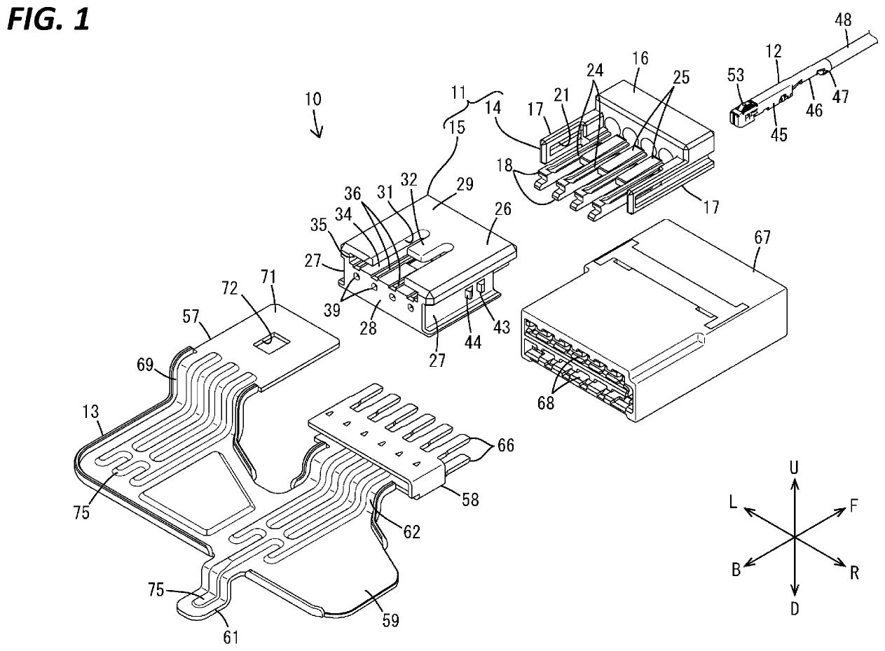

A connector 10 provided in an electrically conductive path branched part of a vehicle is illustrated in this embodiment. As shown in FIG. 1, the connector 10 is provided with a housing 11, a plurality of connection terminals 12 to be accommodated into the housing 11 and a mounting terminal 13 to be fit and mounted into the housing 11.

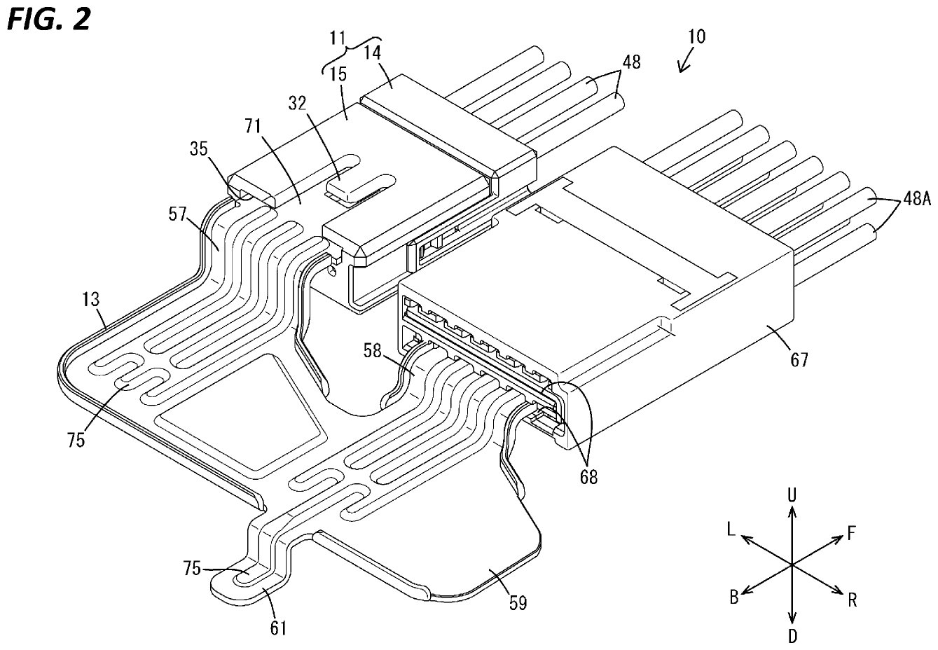

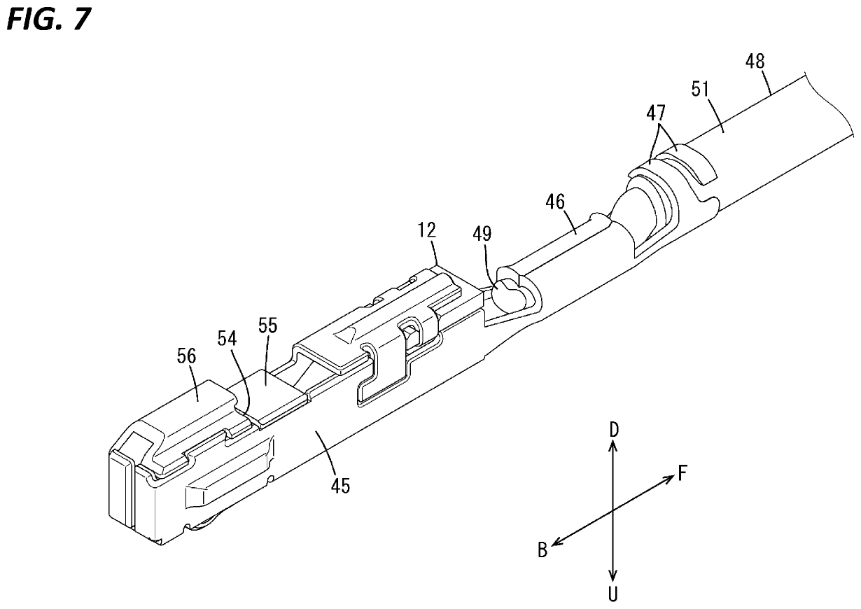

In the case of this embodiment, the mounting terminal 13 is a ground terminal, electrically connected to the respective connection terminals 12 inside the housing 11 and electrically connected to a ground side such as an unillustrated vehicle body outside the housing 11. Note that, in the following description, a side of the mounting terminal 13 to be mounted into the housing 11 is referred to as a front side concerning a front-rear direction. A vertical direction is synonymous with a height direction and based on a vertical direction of each figure except FIG. 7. A lateral direction is synonymous with a width direction and based on a lateral direction of FIGS. 1 and 2. F, B, U, D, L and R in figures respectively represent front, rear, upper, lower, left and right sides. These directions are merely determined for the convenience of description and do not limit a mode during use.

### Housing

The housing 11 is made of synthetic resin and has a flat shape rectangular in a plan view as a whole as shown in FIG. 2. The housing 11 includes a first housing 14 and a second housing 15 divisible from each other. The first housing 14 is arranged movably to a temporary locking position and a complete locking position with respect to the second housing 15.

The first housing 14 and the second housing 15 are formed of mutually different materials. Specifically, the second housing 15 is formed of a material higher in rigidity than the first housing 14. For example, the first housing 14 is formed of PBT (polybutylene terephthalate) resin, and the second housing 15 is formed of PBT resin with an inorganic filler such as glass.

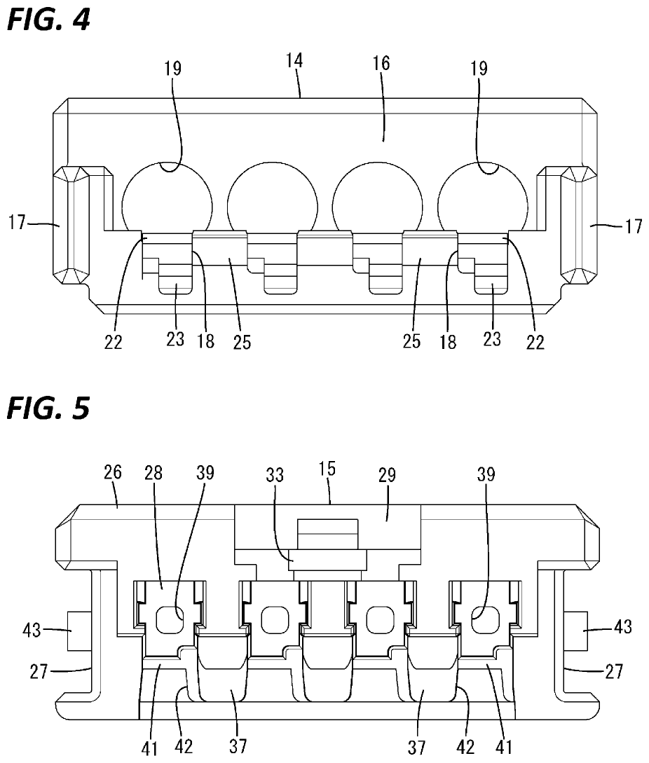

As shown in FIGS. 1 and 4, the first housing 14 includes a base portion 16 extending long in the lateral direction, housing locking portions 17 projecting rearward from both left and right end parts of the base portion 16 and a plurality of locking lances 18 projecting rearward from positions between the housing locking portions 17 in the base portion 16.

A plurality of through holes 19 are formed to penetrate through the base portion 16. The respective through holes 19 have a circular cross-sectional shape and are arranged side by side in a row in the width direction in the base portion 16. The connection terminal 12 is inserted through the through hole 19 from front.

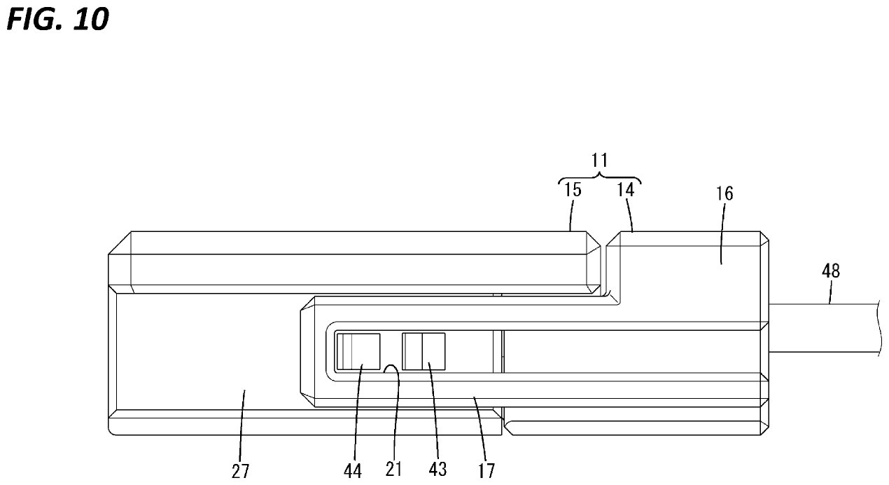

As shown in FIGS. 1 and 10, each housing locking portion 17 is in the form of a rectangular frame long in the front-rear direction. A locking hole 21 is formed to penetrate inside each housing locking portion 17.

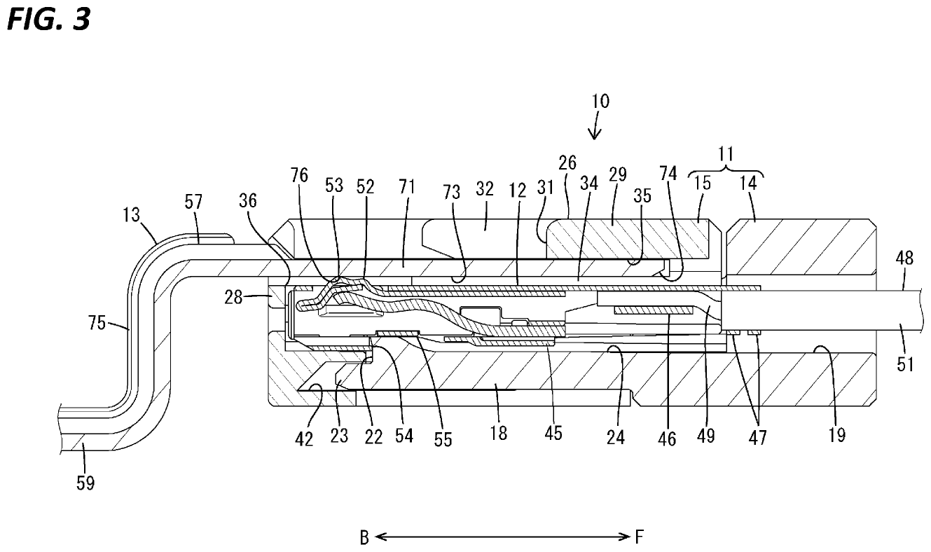

As shown in FIG. 4, the respective locking lances 18 are arranged side by side in a row in the width direction at positions corresponding to the respective through holes 19 in the rear surface of the base portion 16. As shown in FIG. 3, a locking projection 22 is formed to project upward and a restricting piece 23 is formed behind the locking projection 22 on a tip part of each locking lance 18. Further, as shown in FIG. 1, the upper surface of each locking lance 18 is recessed to form a guiding groove 24 extending in the front-rear direction. The guiding groove 24 extends in the front-rear direction and is open forward of the first housing 14, and the rear end thereof is closed by the locking projection 22. The connection terminal 12 is movable along the guiding groove 24 and lockable by the locking lance 18.

Further, as shown in FIG. 4, the first housing 14 includes a plurality of partitioning portions 25 at positions between the locking lances 18 adjacent in the width direction. As shown in FIG. 1, each partitioning portion 25 projects from the rear surface of the base portion 16 to have a length, which is about half the length of each locking lance 18.

As shown in FIGS. 1 and 5, the second housing 15 includes a flat plate-like upper wall 26, a pair of side walls 27 projecting downward from both widthwise side edges of the upper wall 26 and an end wall 28 projecting downward from a rear end part of the upper wall 26. Both widthwise side edges of the end wall 28 are integrally coupled to rear end parts of the side walls 27.

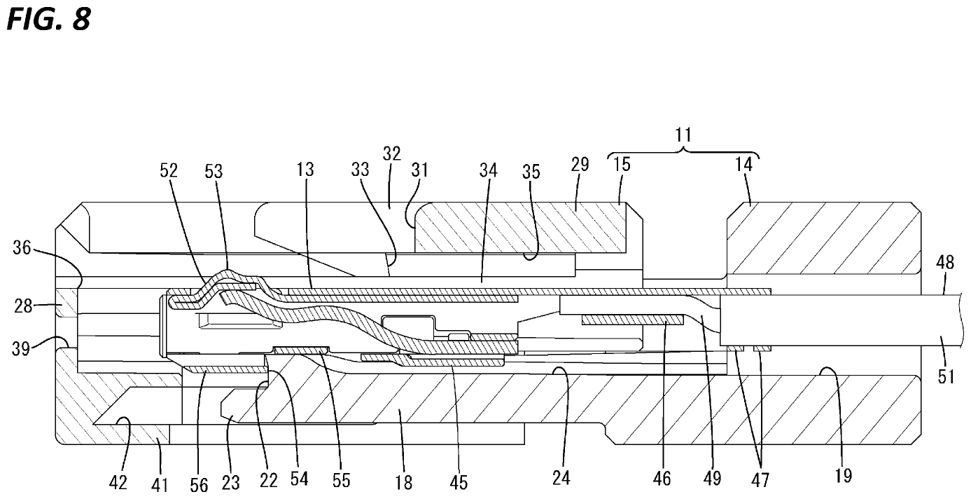

As shown in FIG. 1, the upper wall 26 includes a bridge portion 29 bridged between the upper ends of the respective side walls 27 and a recess 31 recessed from the rear end to the bridge portion 29 in a widthwise central part. The upper wall 26 is formed with a resiliently deformable lock portion 32 projecting into the recess 31 from the bridge portion 29. As shown in FIG. 8, the lock portion 32 includes a claw-like lock projection 33 projecting downward on a tip part. The lock projection 33 of the lock portion 32 can be fit and locked to a later-described lock receiving portion 72 of the mounting terminal 13.

Further, as shown in FIGS. 1 and 3, the second housing 15 includes a partition wall 34 below the upper wall 26 and a slit 35 long in the width direction between the upper wall 26 and the partition wall 34 and between the respective side walls 27. The slit 35 is open rearward of the second housing 15. A later-described guide portion 71 of the mounting terminal 13 can be positioned and fit into the slit 35.

As shown in FIG. 1, a plurality of openings 36 are formed to penetrate through the partition wall 34. The respective openings 36 are arranged side by side in the width direction at positions corresponding to the respective locking lances 18 in an assembled state of the first housing 14 and the second housing 15. Further, the partition wall 34 is formed with a plurality of separation walls 37 projecting downward at positions between the openings 36 adjacent in the width direction as shown in FIG. 5. The respective separation walls 37 are arranged in a rear part of the partition wall 34 to be continuous with the respective partitioning portions 25 of the first housing 14 in the front-rear direction in the assembled state of the first housing 14 and the second housing 15.

As shown in FIG. 1, the end wall 28 is formed with a plurality of inspection holes 39 penetrating at positions overlapping the respective openings 36 in the lateral direction. Each inspection hole 39 has a circular cross-sectional shape and has an opening diameter smaller than that of each through hole 19. An unillustrated probe pin for checking a conductive state of the connection terminal 12 in the housing 11 is insertable through each inspection hole 39.

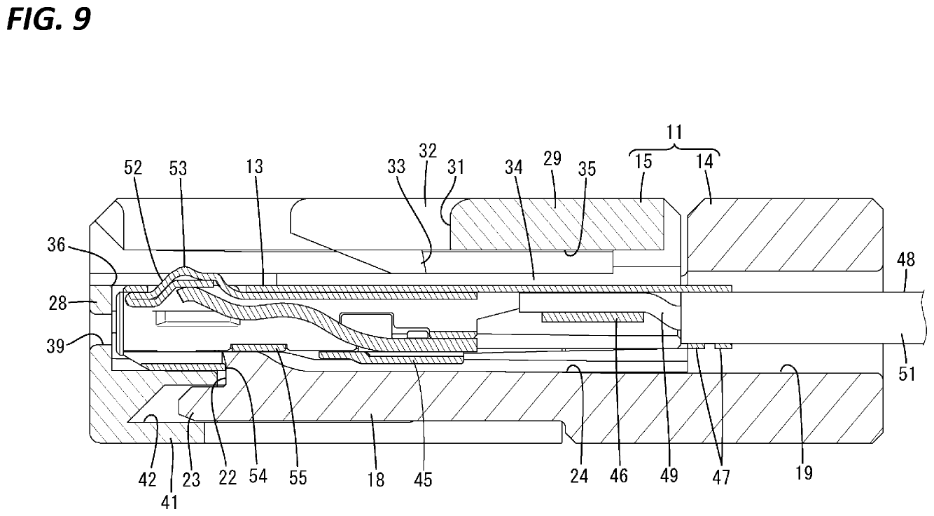

As shown in FIG. 5, a plurality of retainer portions 41 are formed to project at positions below the respective inspection holes 39 and between the separation walls 37 adjacent in the width direction in the front surface of the end wall 28. As shown in FIGS. 8 and 9, the front surface of each retainer portion 41 is recessed to form a restricting recess 42. The restricting piece 23 of each locking lance 18 of the first housing 14 is insertable into the restricting recess 42 of each retainer portion 41.

As shown in FIGS. 1 and 10, a pair of a temporary locking portion 43 and a complete locking portion 44 are formed on the outer surface of each side wall 27, i.e. each of the left surface of the left side wall 27 and the right surface of the right side wall 27, while being spaced apart in the front-rear direction. Each of the temporary locking portion 43 and the complete locking portion 44 is in the form of a projection and lockable to the housing locking portion 17.

### Connection Terminal

The connection terminal 12 is formed, such as by bending an electrically conductive metal plate. As shown in FIG. 7, the connection terminal 12 includes a box portion 45 in the form of a rectangular tube shaped to extend long in the front-rear direction and having a closed rear surface, a wire barrel portion 46 in the form of an open barrel connected in front of the box portion 45, and an insulation barrel portion 47 in the form of an open barrel connected in front of the wire barrel portion 46. The wire barrel portion 46 is crimped and electrically connected to a core wire 49 of a wire 48. The insulation barrel portion 47 is crimped and mechanically connected to a coating 51 of the wire 48. Note that the wire 48 connected to each connection terminal 12 is pulled out forward from the housing 11 through the through hole 19 of the base portion 16 as shown in FIG. 3.

An upper wall part of the box portion 45 has a double wall structure composed of an outer wall part and an inner wall part. The inner wall part of the box portion 45 is formed with a resiliently deformable resilient contact piece 52. The resilient contact piece 52 includes a contact point portion 53 exposed upward from the inner wall part through a cut of the outer wall part.

As shown in FIG. 7, a lower wall part of the box portion 45 is formed with a lance receiving portion 54. The lance receiving portion 54 is formed between front and rear walls in the lower wall part of the box portion 45 and includes a closing wall 55 partitioning between the inside and outside of the box portion 45. The rear wall of the lower wall of the box portion 45 is formed with a bulging portion 56 defining the rear end of the lance receiving portion 54 by being bent downward into a U shape. As shown in FIG. 8, the locking projection 22 of the locking lance 18 is lockable to the lance receiving portion 54.

### Mounting Terminal

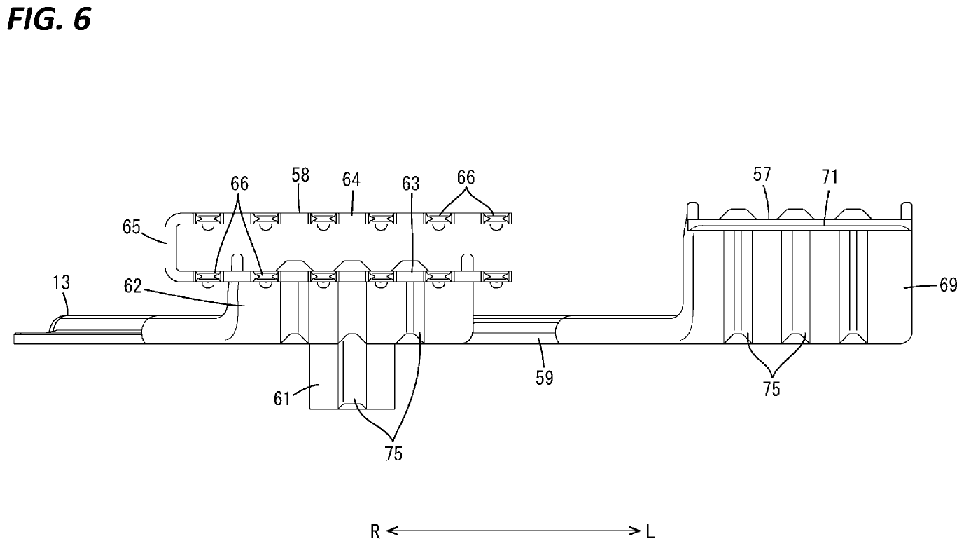

The mounting terminal 13 is formed, such as by bending an electrically conductive metal plate. As shown in FIGS. 1 and 6, the mounting terminal 13 includes a body portion 57, a branched portion 58 and a coupling portion 59. The coupling portion 59 is in the form of a flat plate extending along the front-rear direction and lateral direction and includes a mounting piece 61 bent from and extending from a rear end. The mounting piece 61 is fixed to the ground side such as a vehicle body.

The branched portion 58 and the body portion 57 are arranged side by side in the lateral direction via the coupling portion 59. As shown in FIG. 6, the branched portion 58 includes a base end portion 62, a lower plate portion 63, an upper plate portion 64, a side plate portion 65 and a plurality of connection pieces 66. The base end portion 62 is in the form of a plate rising from a right side of FIG. 1 on the front edge of the coupling portion 59. The lower plate portion 63 is in the form of a flat plate and includes parts projecting forward from an upper part of the base end portion 62 and protruding toward both left and right sides. The upper plate portion 64 is also in the form of a flat plate and facing in parallel to the lower plate portion 63 above the lower plate portion 63. The side plate portion 65 is coupled to the right side edge of each of the upper plate portion 64 and the lower plate portion 63.

The plurality of connection pieces 66 are in the form of tabs and shaped to project forward from the front edge of each of the upper plate portion 64 and the lower plate portion 63. The respective connection pieces 66 are arranged laterally side by side on the front edge of each of the upper plate portion 64 and the lower plate portion 63.

As shown in FIGS. 1 and 2, a joint housing 67 is fit to the branched portion 58 from front. The joint housing 67 is made of synthetic resin, has a flat shape rectangular in a plan view, and is one size larger than the housing 11.

A pair of upper and lower mounting grooves 68 are open in the rear surface of the joint housing 67. The upper plate portion 64 and the lower plate portion 63 are respectively inserted into the pair of upper and lower mounting grooves 68 from behind. Further, a plurality of unillustrated female terminal fittings are inserted into the joint housing 67 from front. The respective female terminal fittings are facing the pair of upper and lower mounting grooves 68, have the respective connection pieces 66 inserted thereinto and are electrically connected to the branched portion 58. Further, the female terminal fittings are respectively electrically connected to end parts of wires 48A. As shown in FIG. 2, the respective wires 48A are pulled out forward from the front surface of the joint housing 67.

As shown in FIG. 6, the body portion 57 has a simple structure as compared to the branched portion 58 and includes a basis portion 69 and a guide portion 71. The basis portion 69 is in the form of a plate rising from a left of FIG. 1 on the front edge of the coupling portion 59. The body portion 57 has such rigidity to be resiliently undeformable as a whole.

The guide portion 71 is in the form of a flat plate having a rectangular plan view shape as a whole and shaped to continuously extend in the front-rear direction from an upper part of the basis portion 69 while having the same width as the basis portion 69. The guide portion 71 is arranged to be higher than the coupling portion 59 via the basis portion 69. As shown in FIG. 2, the guide portion 71 is fittable into the slit 35 with loose movements in the height direction and width direction restricted. The guide portion 71 has a plate thickness corresponding to a vertical gap of the slit 35 as shown in FIG. 3. The guide portion 71 has a width corresponding to an opening width of the slit 35. As shown in FIG. 1, the lock receiving portion 72 is formed to penetrate through a central part of the guide portion 71. The lock receiving portion 72 has a rectangular plan view shape and has such opening dimensions that the lock projection 33 of the lock portion 32 is fittable thereinto.

As shown in FIG. 3, the lower surface of the guide portion 71 has a connecting part 76 to be held in contact with the contact point portions 53 of the resilient contact pieces 52 of the connection terminals 12 in a rear part near the basis portion 69. As shown in FIG. 3, the lower surface of the guide portion 71 is formed with a slide-contact surface 73 in a long range in the front-rear direction from the front end to the connecting part 76 in the rear part. The contact point portions 53 of the resilient contact pieces 52 can slide in contact with the slide-contact surface 73 of the guide portion 71. The guide portion 71 is formed with an inclined surface 74 inclined rearward toward the connecting part 76 from the front surface to the slide-contact surface 73. Further, a plurality of ridge portions 75 are provided laterally side by side on a part from one side (left side of FIG. 1) of the coupling portion 59 to a rear part of the guide portion 71 and a part from the other side (right side of FIG. 1) of the coupling portion 59 to a rear part of the lower plate portion 63.

### Fitting Structure and Functions

The joint housing 67 is fit to the branched portion 58 of the mounting terminal 13. The respective connection pieces 66 of the branched portion 58 are electrically connected to the respective unillustrated female terminal fittings.

On the other hand, the first housing 14 is held at the temporary locking position with respect to the second housing 15. At the temporary locking position, the temporary locking portions 43 of the second housing 15 are fit and locked in the locking holes 21 of the housing locking portions 17. Further, at the temporary locking position, the restricting pieces 23 of the locking lances 18 are arranged in front of and away from the retainer portions 41 as shown in FIG. 8. Thus, the locking lances 18 are in a resiliently deformable state.

When the first housing 14 is at the temporary locking position, the connection terminal 12 is inserted into the housing 11 from front. In an insertion process, the bulging portion 56 of the connection terminal 12 is fit into the guiding groove 24 of the locking lance 18 through the through hole 19 of the base portion 16 to guide an inserting operation of the connection terminal 12. When the insertion is completed, the locking projection 22 of the locking lance 18 is fit in the lance receiving portion 54 and in contact with the closing wall 55 as shown in FIG. 8, whereby the inserting operation of the connection terminal 12 is stopped.

Subsequently, the first housing 14 is pushed rearward with respect to the second housing 15 and brought to the complete locking position. At the complete locking position, the complete locking portions 44 of the second housing 15 are fit and locked in the locking holes 21 of the housing locking portions 17 as shown in FIG. 10. Further, at the complete locking position, the restricting pieces 23 of the locking lances 18 are fit in the restricting recesses 42 of the retainer portions 41 and the resilient deformation of the locking lances 18 is restricted as shown in FIG. 9. The contact point portions 53 of the resilient contact pieces 52 of the connection terminals 12 are arranged to be exposed upward through the openings 36 of the second housing 15.

Subsequently, the housing 11 is fit to the body portion 57 of the mounting terminal 13. Here, the guide portion 71 of the body portion 57 is positioned and fit into the slit 35 of the second housing 15. In a fitting process, the contact point portions 53 of the connection terminals 12 slide in contact with the inclined surface 74 of the guide portion 71 and the resilient contact pieces 52 are resiliently deformed downward. As the fitting proceeds, the contact point portions 53 of the connection terminals 12 slide in contact with the slide-contact surface 73 of the guide portion 71 and external matters such as oxide films formed on the contact point portions 53 are wiped and removed by the guide portions 71.

When the housing 11 is properly fit to the body portion 57 of the mounting terminal 13, the contact point portions 53 properly contact the connecting part 76 of the guide portion 71 and the connection terminals 12 and the mounting terminal 13 are electrically connected with the resilient contact pieces 52 of the connection terminals 12 resiliently deformed as shown in FIG. 3.

Further, in the fitting process, the guide portion 71 is positioned in the slit 35 of the second housing 15 to guide a fitting operation of the mounting terminal 13 and the housing 11. Then, the lock portion 32 slides in contact with the upper surface of the guide portion 71 to be resiliently deformed. When the fitting is completed, the lock portion 32 resiliently returns, the lock projection 33 is fit into the lock receiving portion 72, and the housing 11 and the mounting terminal 13 are held in the fitting state.

In the case of this embodiment, since the guide portion 71 of the mounting terminal 13 is directly positioned in the slit 35 of the housing 11 in the fitting process of the mounting terminal 13 and the housing 11, a receptacle, into which the housing 11 is fit, can be omitted from the side of the mounting terminal 13. This can contribute to the miniaturization of the connector 10. Further, since the receptacle needs not be considered for stacking tolerances, the connection accuracy of the mounting terminal 13 and the connection terminals 12 can be improved.

Moreover, since the mounting terminal 13 contacts and is electrically connected to the contact point portions 53 exposed on the outer surfaces of the connection terminals 12 and does not include tabs or the like to be inserted into the box portions 45 of the connection terminals 12, the configuration of the mounting terminal 13 can be simplified and stacking tolerances can be reduced more.

Further, since the guide portion 71 includes the lock receiving portion 72 lockable to the lock portion 32 of the housing 11, the configuration on the side of the mounting terminal 13 can be simplified as compared to the case where the lock receiving portion 72 is provided separately from the guide portion 71.

Further, since the second housing 15 is higher in rigidity than the first housing 14, a structure for positioning and holding the guide portion 71 in the slit 35 and locking the lock portion 32 to the guide portion 71 is easily realized. In contrast, the first housing 14 is easily flexible to enable the deflection of the locking lances 18.

### Other Embodiments of Present Disclosure

The embodiment disclosed this time should be considered illustrative in all aspects, rather than restrictive.

In the case of the above embodiment, the guide portion of the mounting terminal is configured to be electrically connected to the contact point portions of the connection terminals. However, as another embodiment, the mounting terminal may include a connecting part to be electrically connected to the contact point portions of the connection terminals in a part other than the guide portion.

In the case of the above embodiment, the second housing is configured to include the lock portion and the retainer portions. However, as another embodiment, the second housing may be configured to include either the lock portion or the retainer portions.

In the case of the above embodiment, the housing is configured to be divisible into the first housing and the second housing. However, as another embodiment, the housing may be configured to be divisible into a housing member including cavities for accommodating the connection terminals and a lock part for locking the mounting terminal and a dedicated retainer member for retaining the connection terminals. In this case, the housing member may be provided with a slit for positioning the guide portion. Alternatively, the housing may be composed of a single member as a whole.

### LIST OF REFERENCE NUMERALS

10 connector

11 housing

12 connection terminal

13 mounting terminal

14 first housing

15 second housing

16 base portion

17 housing locking portion

18 locking lance

19 through hole

21 locking hole

22 locking projection

23 restricting piece

24 guiding groove

25 partitioning portion

26 upper wall

27 side wall

28 end wall

29 bridge portion

31 recess

32 lock portion

33 lock projection

34 partition wall

35 slit

36 opening

37 separation wall

39 inspection hole

41 retainer portion

42 restricting recess

43 temporary locking portion

44 complete locking portion

45 box portion

46 wire barrel portion

47 insulation barrel portion

48, 48A wire

49 core wire

51 coating

52 resilient contact piece

53 contact point portion

54 lance receiving portion

55 closing wall

56 bulging portion

57 body portion

58 branched portion

59 coupling portion

61 mounting piece

62 base end portion

63 lower plate portion

64 upper plate portion

65 side plate portion

66 connection piece

67 joint housing

68 mounting groove

69 basis portion

71 guide portion

72 lock receiving portion

73 slide-contact surface

74 inclined surface

75 ridge portion

76 connecting part

1. A connector, comprising:
a housing;
a connection terminal to be arranged inside the housing; and
a mounting terminal to be connected to the connection terminal,
the mounting terminal including a flat plate-like guide portion, and
the housing including a slit for positioning the guide portion.

2. The connector of claim 1, wherein:
the connection terminal includes a contact point portion exposed on an outer surface, and
the guide portion contacts and is connected to the contact point portion.

3. The connector of claim 2, wherein:
the guide portion has a slide-contact surface between a connecting part to be connected to the contact point portion and a tip in an insertion direction into the slit, the contact point portion being slidable in contact with the slide-contact surface, and
the guide portion has an inclined surface receding to the connecting part side toward the slide-contact surface on the tip.

4. The connector of claim 1, wherein:
the housing includes a resiliently deformable lock portion, and
the guide portion includes a lock receiving portion to be locked by the lock portion.

5. The connector of claim 1, wherein:
the housing is configured to be divisible into a first housing and a second housing,
the first housing includes a resiliently deformable locking lance for locking the connection terminal, and
the second housing includes the slit and a retainer portion for restricting resilient deformation of the locking lance and is higher in rigidity than the first housing.

6. The connector of claim 5, wherein the second housing includes a resiliently deformable lock portion for locking the guide portion.
